(19) United States
(12) Patent Application Publication
(10) Pub. No.: US 2006/0031114 A1
(43) Pub. Date: Feb. 9, 2006

(54) Interactive personal information system and method

(76) Inventor: Oleg Zommers, Moscow (RU)

Correspondence Address: ROBERTS ABOKHAIR & MARDULA, SUITE 1000, 11800 SUNRISE VALLEY DRIVE, RESTON, VA, 20191, US

(21) Appl. No.: 11/245,229

(22) Filed: Oct. 6, 2005

Related U.S. Application Data
(62) Division of application No. 09/603,216, filed on Jun. 26, 2000, now abandoned.
(60) Provisional application No. 60/158,562, filed on Oct. 8, 1999.

(30) Foreign Application Priority Data
Sep. 22, 1999 (RU) 99119985

(51) Int. Cl. G06F 17/30

(52) U.S. Cl. 705/10

(57) ABSTRACT

The interactive personal information system and method delivers personalized information to users by having a publisher, or a multilevel structure of primary and secondary publishers, collect information items into at least one database for periodic delivery of collections of information items to users as personalized information. The collections are selected based on user profiles that are refined based on collecting and analyzing subjective responses from the users. The personalized information can be delivered in various formats and can include various interactive tools to increase its utility. Different levels of publishers can provide information items and response analysis to other publishers. Information items can be sought by publishers based on user requests and response analysis.

This application claims the benefit of U.S. Provisional Application No. 60/158,562, filed Oct. 8, 1999.

### FIELD OF THE INVENTION

This invention relates generally to delivering personalized information to people. More particularly, this invention is drawn to an interactive personal information system and method for the delivery of information items collected from various sources to users by a publisher and/or secondary publisher. Users have profiles which are used in the selection of the information and can submit responses to the delivered information which are used to update their profile.

### BACKGROUND INFORMATION

Various personal information delivery systems are known in the prior art. Numerous services on the Internet, such as “My Yahoo” and “My Netscape”, allow users to select which news, sports, weather, etc. will be displayed on a customized Internet web page. As users interests change, they must manually update their selections.

Certain Internet-based publications, such as ZDNet News with its “Talkback” feature (see http://www.zdnet/zdnn/), allow readers to post responses to news stories. These responses, however, are not used to determine which future articles will be available to those users who post responses.

U.S. Pat. No. 5,761,662 to Dasan discloses an Internet-based system for delivering browser-based personalized newspaper to users based on their submitted profiles. Profiles are changed by user editing.

U.S. Pat. No. 5,537,586 to Amram et al. discloses a method for extracting a preferred set of textual records from a database based on predefined category structures. A user manager (i.e., not the subscriber) ranks relevance of records and the system compares samples of actual usage by subscribers to update the subscriber profile. Information beyond usage data is not collected from subscribers.

U.S. Pat. No. 5,428,778 to Brookes discloses a database method and system for disseminating information to a user which includes updating keyword parameters after comments have been added to information items. User interest profiles are fixed by the users.

U.S. Pat. No. 5,339,239 to Manabe et al. discloses a system for requesting and receiving various kinds of service information from an organization's host computer via access terminals, storing the information on IC memory cards, and looking at the information using a portable personal terminal.

U.S. Pat. No. 5,754,939 to Herz et al. discloses a system which assigns profiles to target objects and users, compares the profiles to present a list to the user, and updates target object and user profiles based on the objective feedback of user selection of target objects (i.e., usage data).

U.S. Pat. No. 5,861,881 to Freeman et al. discloses a computer based, multimedia program delivery system for interactively combining multiple audio/video data streams. Interactive user commands control program presentation.

U.S. Pat. No. 5,793,497 to Funk and U.S. Pat. No. 5,937,162 to Funk et al. discloses an e-mail or facsimile “newspaper” delivery system with a user customized personal configuration file that controls content, format, and timing of the delivered e-mails or facsimiles. Third party messages can also be forwarded to users via the system.

U.S. Pat. No. 5,890,152 to Rapaport et al. discloses a personal feedback browser and personal profile database for obtaining media files. The browser selects files based on the personal profile database and adjusts the personal profile database based on user selection and absorption of media files (i.e., usage data).

U.S. Pat. No. 5,699,526 to Siefert discloses a system for searching and ordering resources based on database profiles.

U.S. Pat. No. 5,724,424 to Gifford discloses a system for purchasing items on the Internet wherein ads are displayed in response to user requests, and items are purchased and delivered in response to a payment order message from the buyer or merchant computer.

U.S. Pat. No. 5,931,901 to Wolfe et al. discloses a system and method for Internet delivery of programmed music and targeted advertising messages based on subscriber dossiers which are stored and updated. However, no data beyond usage data is collected or used to update the dossiers.

U.S. Pat. No. 5,918,213 to Bernard et al. discloses a system and method for automated remote previewing and purchasing of multimedia products. A membership profile with payment and shipping information facilitates automation of the process and minimizes repetitive input of information.

U.S. Pat. No. 5,845,262 to Nozue et al. discloses electronic delivery of press information to vending machines where the information is written to a recording medium for use by a consumer.

U.S. Pat. Nos. 5,696,965 and 5,724,521 to Dedrick discloses a system for delivering advertisements to users based on user profiles containing statistical data and U.S. Pat. No. 5,710,884 to Dedrick discloses a system for automatically updating a personal profile based on objective user information gathered from monitoring the users electronic consuming habits while online (i.e., usage data).

None of this prior art discloses or suggests the collection of responses related to the content, user requests, inquiry responses, and/or formalized user statements after delivery of personalized information. Additionally, the prior art does not disclose or suggest multiple levels of publishers and secondary publishers for the delivery of personalized information.

### BRIEF SUMMARY OF THE INVENTION

It is an object of the present invention to provide interactive, personalized information to users by having a publisher, or a multilevel structure of a primary and at least one secondary publisher, collect information items into at least one database for periodic delivery of collections of information items to users as personalized information. The collections are selected based on user profiles that are refined based on collecting and analyzing responses from the users. The personalized information can be delivered in various formats and can include various interactive tools to increase its utility. Different levels of publishers can provide information items and response analysis to other publishers. Information items can be sought by publishers based on user requests and response analysis.

Various methods of increasing the utility of the information include: (i) delivering content in a form suitable for use by a user to provide personal organizer functions and (ii) delivering content in electronic form provided with interactive tools such as navigating tools, archiving tools, annotating tools, calendar tools, printing tools, and communication tools.

More particularly, it is an object of the invention to provide a method of delivering personalized information to users involving collecting information items, storing them on a database, storing user profiles on a database, periodically delivering a collection of information items to users as personalized information, wherein at least a percentage of content is chosen based on their user profile, collecting responses related to the (i) subjective views of the content, (ii) user requests, (iii) inquiry replies, and/or (iv) formalized user statements, and refining the user profiles based, at least in part, on those responses.

It is yet another object of the present invention to provide a personal interactive information system having: a database with a plurality of information items stored thereon, user profiles stored on a database, means for periodically delivering a collection of information items to said users as personalized information wherein at least a percentage of content is chosen based on their user profile, means for collecting subjective responses from users related to the content, and means for refining user profiles based, at least in part, on those responses.

This invention contemplates content from licensed commercial sources, free sources, and independent authors. User responses can include request for specific information that can be fulfilled by independent authors, who, in turn, can be compensated each time their content is used. Information delivery channels include Internet web pages, FTP downloads, e-mail, facsimile transmission, delivered paper hardcopy, magnetic media, optical media, broadcast TV, and radio. Response analysis methods include using information space to derive information vectors. Responses can also be independently analyzed for reasons other than refining user profiles.

Another object of this invention is to provide information “personalized” for groups wherein a plurality of users are associated as a group based on a common attribute, a group profile is formed, a percentage of content delivered to said group is chosen based on the group profile, group information responses are collected from the group regarding the content, and the group profile is refined based, at least in part, on the group responses.

Yet another object of this invention is to collect subjective responses by having users mark paper hardcopy response forms which are then machine-read. These forms can be transmitted by facsimile with machine-reading performed by recognition software. It is an additional object to provide these facsimile response forms with a section for users to create e-mail by having users address and draft messages in said section, indicate whether to send said messages as text or graphics files, have the section recognized as text or graphics by recognition software, and having the message sent, as addressed, in the indicated format.

It is an additional aspect of this invention to have the user, or a third party designated by the user, select when the information is delivered, such as by time interval, information size, or specific event.

It is yet another object of the invention to allow for user access to certain information items to be linked to the performance by the user of additional tasks, such as authorizing payment or viewing and/or responding to other information items.

### BRIEF DESCRIPTION OF THE DRAWINGS

FIG. 1 discloses a general overview of a publisher embodiment of the invention with an optional distributor.

FIG. 2 disclose a detailed view of the publishing system of the present invention.

FIG. 3 discloses a multilevel, hierarchical embodiment of the invention.

### DETAILED DESCRIPTION OF THE INVENTION

As used herein, the following terms have the following meaning.

Personal or personalized information is any kind of text, audio, or video information delivered to each user.

Information item is a particular self-contained unit of text, audio or video material.

Collection of information items is any set of information items.

Personal information collection is a collection of information items generated personally for each user and periodically delivered to said user.

Issue of personalized information is one copy of the periodically delivered personal information collection.

Information publication or publication is the same as a collection of information items.

Issue of publication is one copy of the periodically delivered information publication.

Publisher is a person or a company who generates and delivers to users collections of information items.

Distributor is a person or a company who delivers to users collections of information items generated by a publisher.

Primary publisher is the main publisher in multilevel hierarchical structure of publishers which is on the top of hierarchy and is responsible for personalized information in general.

Secondary publisher is any publisher in multilevel hierarchical structure of publishers other than primary publisher.

General Concepts

The technical result to be achieved with this invention is an increased efficiency for the system's users by providing them with text, audio and video materials most relevant to their fields of interest and individual preferences; enhanced selectivity and customization of the personalized information that will approach as close as possible the users' individual preferences as statistics on actually collected materials are accumulated; continuous adaptation of materials offered to the changing needs of the users; an expanded range of potential distributors of the personalized information and a shorter period of its delivery; optimization of the network infrastructure enabling generation of a virtually unlimited set of topical information collections while retaining a single center which implements the search for, selection, indexing and systematization of materials; and an expanded range of the information sources which are used in generating personalized information.

The invention is based on the proposal that personalized information should be prepared not only on the basis of user-selected topical sections but also on the basis of processing data on the materials they have collected before and analysis of their responses as to the quality of the materials and whether they fall within their fields of interest. User's psychological-type may be taken in consideration during personalized information generation and delivering. This makes the system capable of self-teaching and produces a very high customization level for the personalized information which will continuously increase as individual statistics accrue. The user-selected topical sections are only important at the initial stage of the user's interaction with the system, when the first issues of the personalized information are prepared with little or no statistical data on the specific field of interest or preferences of the user. Their role will be continuously decreasing as information on actually collected materials is accumulated. Personal topical interests, preferences and psychological-type of each user are stored in the user's user profile. The principal role in the preparation and distribution of personalized information is played by its publisher, who selects information materials from the available sources and places them in each current issue of the personalized information, which can be thought of as a publication. Each of such issues may be prepared personally for each user or group of users, based on their field of interest and preferences.

A group of users is hereinafter understood as those users who have common interests or other common attributes and receive personalized information, at least a part of which is common to all members of the group and adapted to their group interests through a combined analysis of responses from all the group members. In other words, each new issue of the personalized information will include those information materials that fall within the field of interest and meet the preferences of one or more members of the group.

Personalized information can be distributed both directly by the publisher via his own information server and over a network of independent distributors authorized by the publisher to register users and distribute the personalized information via their servers. This allows, first, a virtually unlimited expansion of the range of distributors and, second, a specialization of the personalized information by a preferred incorporation of those topical materials that fit the field of interest of a specific distributor. However, the publication itself will always be prepared in a centralized manner, that will not require the independent distributors to use high computer capacity, lease expensive dedicated information channels or employ special staff to operate the server segment of the system.

Anyone who has access to the information server of the publisher or one of the independent distributors over the Internet or via any other communication channel or connection may subscribe to receive personalized information. To this end, it is enough for a user to register on the server of the publisher or a distributor, indicating an initial field of interest and carrying out some additional setup in order to define the method for delivery of the personalized information, the volume of each issue etc. Registration through a distributor's server enables the prospective user to receive a specialized personalized information preferably including text, audio and video materials on a certain topic that reflects the field of interest of the distributor. For instance, a car showroom owner could become a distributor of specialized personalized information devoted to automobile issues, and its subscribers would receive the most complete information on this specific topic.

Each subscriber to the personalized information will be assigned a unique password or identifier in order to access the server of the publisher or an independent distributor. This warrants absolute confidentiality of information and reliable delivery of the publication personally to its subscriber. The password assigned during registration will be used whenever the information server is accessed to receive another issue of the publication or modify the individual setup parameters. It can be changed at the user's desire at any time after the initial registration.

Any user can use a user terminal in order to work with an issue of personalized information, including initial registration, initial selection of topics and parameter setup. The most important example of a user terminal is a personal computer connected to the Internet or having access to the server of the publisher or an independent distributor via any other channel or connection. If a user terminal has no physical capacity of feedback to the publisher's server, issues of the personalized information could only be adapted to the user's field of interest and preferences by the user's selecting those topical sections and fields which he is interested in. The user-defined parameters of personalized information will determine the mode of its delivery, the maximum volume of each particular issue and a number of other auxiliary characteristics. Users can learn about the existence of personalized information and obtain details of its publisher and distributors through periodically updated advertisements or advertising collections of information items published and distributed by the publisher via generally available printed and electronic media. In particular, promotional issues of the personalized information, updated on a daily basis, may be posted on the websites of the publisher and independent distributors. They should include materials reflecting as fully as possible the fields of interest of all previously registered users. In addition, these issues could be generated in accordance with the personal profiles of topical fields furnished for this purpose by any of the previously registered users.

Each issue of the personalized information is delivered to users directly via the publisher's server or via the server of one of the independent distributors. In one embodiment, the user should first contact the server indicating his individual password or identifier. One of the available delivery options should be selected by the user as part of the system's setup. The simplest of them is delivery at the user's direct request sent to the publisher's or distributor's server. Another basic option is delivery of current issues according to a used-defined schedule. More complicated options require to specify an event upon the occurrence of which a new issue should be delivered to the user. An example of such an event is the accumulation of a user-defined amount of unpublished information materials that should be enough to generate a new issue. Also, the user may designate a third party to decide when the information get delivered.

When delivery is in response to a specific event, the personalized information can be limited to a single information item concerning the event.

All issues of the personalized information prepared on the publisher's server will be stored in the central database. This will enable the user both to refer to new and return to previously received issues. Once a request for a new issue is received from the user, the central database will be checked for any issues yet undelivered which have been generated for this user or group of users. If any of them is available, it will be promptly delivered to the user. If there are no issues that have not been previously delivered to the user, a request will be formed for generation of a new issue that then will be placed in the database and sent to the user. The information sources for the preparation of issues of personalized information may be represented by news and topical sites, channels of authorized news agencies and independent authors who prepare materials for this specific publication. The search engine of the publisher will be continuously monitoring all changes within a certain predefined set of authorized information sources and, wherever new materials appear, download and save them in an interim search database. Then, after they are evaluated for usability in generating future issues of the personalized information and, possibly, preliminarily indexed and classified into topical fields, all newly retrieved materials will be transferred to the publisher's central database. They will be taken out of it when a new issue of the publication is prepared in accordance with the individual fields of interest of a certain user or group of users.

Independent authors supply information materials to the publisher through the author's server of the publisher. All newly received materials will be placed on a temporary basis in the publisher's interim database and, after they are evaluated for usability in generating future issues of the personalized information and, possibly, preliminarily indexed and classified into topical fields, will be then transferred to the publisher's central database. The topics of the materials supplied by independent authors may be based either on the interests of the authors themselves or the topics of interest of the users or independent distributors. In the latter case, information materials are prepared either to the publisher's order based on a review of the registered users' profiles or to the order of independent distributors based on the topics they are interested in themselves. When information materials of any independent author are included in an issue of personalized information, the author can be paid a fee to be remitted to the author's settlement account.

In order to adapt new issues of personalized information as much as possible to the interests, preferences and psychological-types of the users, a user profile will be generated on the publisher's server individually for each registered user and/or group of users of the personalized information. Initially, such a profile may be defined by the topical sections selected by the user from a given predefined set, choosing a user profile of one of the earlier registered users of personalized information, combining profiles of any number of users, specifying a profile generated by a publisher of personalized information or one of these enumerated profiles with the additional selection of some topical sections from a given predefined set. Moreover, the user can supply his initial field of topical interest by referencing to any well-known information sources or information publications. If the user references to a plurality of information sources or information publications, he can specify a percentage of information he wants from each information source or publication he references to. If desired, a user's psychological-type may be evaluated by applying some psychological tests. Test results are stored in the user's user profile or separate psychological profile.

The user profile will further be adjusted, first, on the basis of a review of processed data on the materials previously collected by the user and, second, on the basis of a review of any responses received from the user concerning the quality of the materials and their conformity with the field of his interest. This establishes a dynamic feedback of the personalized information's users directly to its publisher. For the users forming a group according to their interests or some other common attribute, their common group profile will be generated, and may be subject to adjustment through analyzing the topics of the materials collected by all member of the group and any responses received from them. Each member of said group can specify the portion of information materials delivered based on his individual user profile and the portion delivered in accordance with group profile. Moreover, the portions of information items delivered based on individual or group profiles can be specified by a third party.

User profiles are allowed to be used not only for customization of the personalized information but for some special reasons such as marketing researches, interrogation of public opinion, psychological testing, etc.

A user's response to each specific item of material published in any issue of the personalized information will be forwarded to the publisher's server either as an evaluation of the quality of the information material and its conformity with the user's field of interest or in the form of comments. Quality may be evaluated using a conventional scale in points or in a similar manner, e.g. by appropriate positioning of the marker on the display of the user terminal. Comments are represented by ordinary text expressing the user's detailed attitude towards the material supplied. Either, the user's response should be transmitted to the publisher's server in a formalized manner suitable for automatic computer processing. The user's response on paper can be entered and transmitted to the publisher's server using a scanning device.

The publisher of personalized information can include into the issues of publication certain information materials the user is particularly interested in. The publisher may require this user to provide pithy responses to another information item included into the issue before being allowed to access the first item.

In order to expand the overall outlook of a user of an issue of personalized information and to keep him better informed of possible topical fields, each issue of the personalized information may, in addition to information materials fitting the adjusted user profile of the user and/or group of users, include the publisher's materials which were deemed most important at the time of generation of the issue. The collection of those, as well as any other, materials by the user will influence further adjustments to the user's user profile.

When ordering some information materials from a publisher or distributor or specifying the fields of topical interest, a user can specify a priority for each ordered material or topical field. Moreover, prioritizing can be assigned manually (i.e. by the editor) or automatically to all information items collected by a publisher from information sources. Those information materials to which the higher priority has been assigned, are included into issues of personalized information on that basis. Materials of lesser priority are included into the current issue of personalized information if there is any free space before reaching the maximum volume of a particular issue, specified by a user, or are postponed up to the subsequent issues. Usage of a priority allows, in particular, the subdivision of all information materials into hot news or other priority information items or topical fields, and additional comments to them. Hot news, that is the messages with a priority, are supplied to the user in the nearest issue of personalized information. The further comments to them, having a lower priority, will be included into the subsequent issues of personalized information or user can refuse them at all. In general, a user orders additional comments to hot news or other priority information items using a specific request. If the event designated in hot news admits the comments from various points of view or submitted by various authors, the user specifies from what positions and by which of the authors the appropriate event should be commented. Only information materials satisfying those requirements will be included into the subsequent issues of personalized information.

A user of personalized information can require some information item to be continued in at least one of the next issues of personalized information keeping its topical field. From another hand, a user can require some additional information items submitted by the same independent author. These requirements are transmitted to a publisher or distributor of personalized information as a special kind of response containing the request for continuation. Such responses are processed using a special algorithm and generally do not influence a current state of user's profile but are fixed in publisher's database as a separate tag. That is, for example, because information materials having continuation, can relate to some urgent events (fast changes of a political or economic situation, etc.). These events are interesting to a user at the moment of their urgency, but the field of knowledge, in which they occur, does not belong to the field of constant interests of the user. Therefore events, which have interested the user, should not influence the user's user profile. If necessary, the user may need to eliminate some topical sections from his user's profile.

Users of personalized information can also be granted an opportunity to subscribe to the user profiles of other users, provided that the latter have opened their respective profiles for general access. Selecting one of the most suitable profiles would allow newly registered users of the personalized information to adapt its issues to their own interests as quickly as possible. More generally, each user is allowed to import any user profile exported by another user.

Independent distributors will participate in generating issues of the personalized information for their subscribers by establishing a number of topical sections and delivering to the publisher's server their own topical and advertising materials. These topical sections and materials will reflect the field of interests of the specific distributor. Their involvement and use in generating issues of the personalized information will result in generating a specialized publication devoted to the topics that this distributor is interested in. All users registered via the server of an independent distributor will be provided with a specialized topical issue of personalized information reflecting the interests of this distributor. In this case, adaptation to the individual interests of the user or group of users will be carried out in a usual manner, but taking into account the core topics of the specialized personalized information. In addition, independent distributors will also have influence on the generation of issues of the personalized information by introducing their own mechanism for processing users' responses to published materials.

The form in which an issue of personalized information will be delivered to the user terminal will be determined by whether or not the publisher has legal rights to distribute information materials via his server. If the publisher has no such rights, the issue of personalized information will be generated as a set of headlines with summaries of the relevant materials. If one of the headlines is selected at the user terminal, the user will be given access directly to the original information source and, simultaneously, identification details of the collected material will be sent to the publisher's server for further review in order to adjust the profile of the user and/or group of users. In this case, the level of the user's opportunities to work with materials from the personalized information will be determined by the server of the original information source. If the publisher is entitled to distribute information via his server, the personalized information will be generated as headlines with summaries and also include all the respective information materials. When one of the headlines is selected at the user terminal, the user will promptly be granted access to the relevant text, audio or video materials without the need to refer to any outside information sources. Similar to the above, identification details of the collected material will be sent to the publisher's server for further review in order to adjust the profile of the user and/or group of users.

If a user has an interactive user terminal, he will be granted an opportunity and the necessary facilities for interactive work with the materials of the personalized information. The pattern of such work depends on whether or not the publisher has legal rights to distribute information materials via his server or otherwise is determined by whether or not full versions of text, audio or video materials are incorporated in the personalized information. Very generally, this work includes the generation of individual collections of information materials from various issues of the personalized information, establishment of personal information archives, addition of personal comments on materials, placement of bookmarks in selected places in the publication's issues indicating a time to refer to them in the future or activating upon the occurrence of a user-defined event, and addition of new materials to the current issue of the personalized information.

If the personalized information is made up by text documents and if issues of this personalized information contain full texts of information materials, then, at the user's request, the publisher's server adds formatting to the current issue or a user-defined subset of its articles in order to print it out or transmit it by fax. A formatted copy of the issue will be sent to the user terminal and all further work with it can be done without involving the publisher's or distributor's server. In addition, at the user's request and if the user terminal has appropriate physical capability, the user can be provided with a sound version of the current issue of personalized information.

If the personalized information includes audio materials, then, at the user's request, the publisher's server can generate a formatted printed version of its current issue that then will be forwarded to the user terminal.

Registration requires the system's user to enter some information needed by the server to unambiguously identify the user and to allocate the required resources to him. One should distinguish primary registration and registration upon a subsequent entry into the system, e.g. to obtain the current issue of the personalized information. They may differ in the amount of information to be entered. For instance, it would quite enough to type the user's individual password or identifier for a subsequent entry.

The working parameters in the user profile determine the overall functionality of the system and allow its setup in accordance with the individual requirements of a specific user. The most common set of functions and parameters to be set up includes the initial selection of information sections, selection of the delivery mode and definition of the maximum volume for each particular issue of the personalized information. The maximum volume can be specified, for example, as a number of pages if the personalized information is made up by text documents or in time necessary for the user for perusal, listening or review of information materials. The selection of information sections is important for generating the first issues of the personalized information. The selected sections will mark the user's field of interest, and the core material of the publication will be gathered in accordance with them. Any additional material may be included by the server directly serving the user, depending on the adopted strategy of generating each issue of the personalized information. As statistics on the materials collected by the user grow, the initial selection of sections will have ever-decreasing influence on generating each subsequent issue of the personalized information.

Delivery and Interactive Tools

Personalized information is delivered to users by at least one of the following channels: Internet web pages, FTP downloads, e-mail, facsimile transmission, delivered paper hardcopy, magnetic media, optical media, broadcast TV, and radio.

With respect to the delivery mode, four main strategies of delivering new issues to users should are contemplated: upon request, according to a schedule, upon the accumulation of a user-defined amount of new materials, and upon the occurrence of a user-defined event.

The volume of each particular issue may be fixed by indicating, for instance, the maximum allowable number of text pages for text publications or the playback duration for audio and video materials. Moreover, the volume of text publications can be specified as average time necessary for a perusal of information materials. A smaller volume of an issue will lead to a more stringent strategy of material selection.

The appearance of a publication and work with it will substantially depend on the legal rights of its owner or publisher to any information it supplies and his ability to edit materials received from various sources. Two basic alternatives are possible here.

If the owner of the publication has no rights to direct distribution of information through his server, then each issue of the publication will look like as a set of headlines with summaries of the respective materials. The user is allowed to view or listen to the headlines and summaries in order to choose any document he is interested in. By selecting one of the headlines, the user is given access to the original source of the information. Concurrently, notice of the material so collected will be sent to the publisher's server in order to maintain overall statistics to be used in generating the next issue of the personalized information.

If the owner of the publication has full rights to the information it supplies then each issue of the publication will be represented by a set of headlines with summaries of the materials and will also include full versions of all materials in the issue. For publications of the nature of text or audio documents, the user may also receive, at a special request, a formatted copy of the current issue in order, for instance, to print it out or send it by fax.

Work with any received issue of the personalized information will be implemented by viewing or listening to the table of contents with summaries and selecting the materials of interest. In this case, the user will be granted direct access to any selected material without referring to any outside information sources, and notice of the material so collected will be sent to the publisher's server in order to maintain overall statistics and making, on their basis, decisions as to the field of interest and preferences of that specific user. In addition, the user is able to send to the publisher's server his response concerning the quality of the materials published and their conformity with his field of interest.

All materials of an issue will be readily accessible through the table of contents and require no further reference to any outside information sources. For text forms of personalized information, in particular, a thorough browsing of materials is possible by smooth scrolling on a monitor display. The first page bearing the title of the publication could contain an editor's article on a specific topic and summaries of the materials most interesting to the specific user. For audio and video publications, both continuous consecutive playback of materials and immediate direct access to the required document are allowable.

The printout function offers both formatted printout of the entire issue and printing of a certain subset of the materials it contains. The elementary case is the printout of a current article from text-formatted items or a current sound file from an audio-formatted items. In addition, a current item of an issue may be sent by mail to any network user, including Internet users, without any restriction.

Furthermore, the system's users can be given an opportunity to work interactively with materials of their personalized information, including the creation of individual collections of information materials from various issues, establishment of personal information archives, addition of their own comments on materials, placement of bookmarks in selected places in issues indicating a time to refer to them in the future or activating upon the occurrence of a user-defined event, addition of new materials to the current issue of the personalized information, etc. Individual collections of information items and personal information archives should be organized as plurality of sections associated with various fields of user's interests or with one of his projects. All these opportunities will make working with the materials of the personalized information largely similar to the functions of a personal organizer.

Refinement of User Profiles

Another aspect of the invention involves the refinement of user profiles. The preparation of issues of personalized information reflecting field of interests, preferences and psychological types of the users is based on user profiles. The quality of this profile influences how personalized a publication is. Some primary ways of generating and refining user profiles are contemplated by this invention

Originally, a user profile is created for each user and/or group of users of the personalized information during their registration. The original generation of the profile can be carried out in the following different ways.

The simplest way to create a user profile for a user of personalized information is to select some topical fields from a predefined set of topics. This way is easily implemented, but its essential disadvantage is a rather rough reflection of interests of the user if a depth of the tree of available topical fields is not large enough. The use of very deep and detailed classifiers makes it difficult for user to select topics in a proper way, and, moreover, can restrict further refinement of the user profile because of its narrow initial trend.

The other major factor that influences creation of the original user profile, is when a user subscribes to a specialized issue of personalized information. The topical fields offered to the user reflect the main topical orientation of the specialized personalized information. This allows fixing topical fields more closely to the topical interests of the user even if the depth of the tree of available topical fields is very restricted.

The most progressive way to create a user profile is based on use of user profiles of other users or some parts of those profiles. This way has almost no disadvantages, because for a large number of users of personalized information, it is not too difficult to import already generated profiles that reflect someone's field of interests in a proper way. An additional possibility of combining several profiles allows a user to reflect many fields of interests very closely. One possible problem of this approach is with privacy considerations, i.e., that user's profiles are confidential and their disclosure and use should not be allowed without permission. In addition to the topical interests and preferences, user's psychological type may be evaluated and reflected in the user profile or separate psychological profile. Psychological type of each user may be taken in consideration during personalized information generation and delivering. Refinement of earlier generated user profiles can also be carried out in several other ways. This depends, in particular, on user's experience and his ability to estimate a quality of information materials.

First of all, a very strong influence on a user profile of a user or group of users is rendered by a choice of specific materials in previous issues of personalized information. Together with a user's subjective responses reflecting the quality of items, this method forms a basis for generation and improvement of the profile.

However this method is difficult when a user works with topics which are new. Indeed, when starting his work with some new topical fields, the user may not be able to properly evaluate the quality of materials offered to him. Sometimes it is rather difficult to determine which items to view, let alone respond to. In this case, the better results can be achieved with help from specialists or experts in the given topical field. To refine a user profile, the user can select some topical fields and, if necessary, choose a known, trusted expert to evaluate them. This choice can be fixed in the user profile of the user or group of users, and all the items recommended by these experts will be included into forthcoming issues of personalized information. After becoming familiar with a topic, the user can then start making their own evaluations.

A similar result can be achieved if the user selects some specific sources of information for his personalized information to which he trusts in more for any reason. This choice can also be fixed in the user profile and used during generation of the forthcoming issues of personalized information.

Similar methods can also be used for refining group profiles composed of two or more user profiles. Responses can be collected for the group and for the individuals in the group. The improved group profile is useful for such things as customizing information for a family or a particular work group in a single information channel.

Information Filtering

Since publishers of the present invention will have to deal with an enormous number of information items or documents, filtering of information is another aspect of the invention. The problem of information redundancy will increase as the database grows. A primary task here is to release the person from information that is excessive and useless by allocating only the most essential pieces of knowledge.

Personalized information generated in accordance with user's fields of interest and preferences are only the first step in solution of a problem of information redundancy. Further steps should be taken in a direction of dynamic size regulation of particular information materials. This goal could be achieved by the design and implementation of information filters.

The main purpose of an information filter is a dynamic change in the size of text documents so that users are only given the amount of information they need. Passing through a filter, the document decreases in size in such a way and degree as predefined by the filtering method and parameters setting. As a result, the source text may lose many of its details, but remains integral and coherent. It goes without saying that filtered text should preserve the basic content of the source document.

Generally, there are two approaches to information filtering using two kinds of information filters.

The first type of filter is used to decrease the size of the source document up to the specific value, but preserve general content of the document as close as possible. Synopsis generation for papers and other documents is an example of this kind of filtering.

The second approach to information filtering deals with searching for some information related to the specific topical fields in the given document. Searching for some information in accordance with user profiles and preferences of users of personalized information is an example of this approach. This could be done by excerpts.

The synopsis generation, as a special kind of information filtering, is an example of information compression of source text up to an extreme small size when a general content of the source document is still preserved. It is important that text of synopsis could not be found by simple removing of some words and sentences from original document. It should be completely generated by filtering algorithm on the basis of semantic analysis of the source document.

The task of information selection in accordance with given user profile is a quite different kind of information filtering. Here it is not necessary to preserve a content of the source document. On the contrary, it is necessary to save only that part of text that is related to the topical fields designated within user profile. Everything that has not related to specific topical fields should be discarded completely. If the size of the filtered document still exceeds demanded size, the first kind of filtering should be applied to that document.

The operation of an information filter is determined by its type and controlled by predefined set of parameters. As follows from the preceding analysis, the choice of parameters for filter of given type may influence the results of filtering by one of the following ways. First of all, they can restrict the maximum size of the final document. Then the information filter reduces the size of the source document up to the specific value preserving its general content and integrity as close to original one as possible. In order to archive such a result more than one pass through original text may be required.

On the other hand, the parameters of an information filter could determine the information trend of the final document under condition that the required information is really present at the source document. In the simplest case, the size of the final document is not restricted. If, however, it has to be restricted, both kinds of filters should be used simultaneously.

Topical Trends Prediction

One of the problems that a publisher of personalized information has to solve is evaluation of the topical trends and predicting of user's future interests. Such evaluation may be done by analyzing of evolution of topical interests of personal information subscribers during any period of time. Knowing which of topical trends will be of a greatest interest in the future allows the publisher to search ahead of time for new information sources reflecting those topical fields most completely and competently, and make advanced orders to independent authors for some topical materials.

An idea of an information vector may be considered as a logical and mathematical basis for prospective topical trends evaluation. Most generally, any information vector characterizes the evolution of topical interests and preferences of the user, group of users or all subscribers of personalized information during any period of time. Its direction in information space determines those topical fields that will be of a greatest interest in the nearest future. One can consider the concept of information vector in more detail below.

First of all, one can describe a structure of information space, which will be used to analyze topical interests of personalized information subscribers. Two different approaches are available here, both of which lead exactly to the same result.

The first approach is based upon setting a number of topical fields and a definition of a significance level of each of them for any subscriber of personalized information. One can also introduce a coordinate system and suppose that each of its axes will correspond to one of the topical fields. A significance level of each topical field for any subscriber will be specified as a distance from the origin of coordinate system measured along the corresponding coordinate axis. Significance level may be expressed in many different ways using one of the known methods, for example, it may be represented as a value characterizes how frequently subscriber applies to a given topical field. The result is an N-dimensional coordinate space, where N equals to total number of topical fields. Points of such constructed coordinate space will represent topical interests of subscribers expressed in terms of significance level of each topical field.

Another approach to an information space definition does not assume a preliminary classification of information materials into some topical fields, but is based upon statistical evaluation of the frequency with which each word or word collocation appears in all information materials collected by the subscriber. In this case, the dimension of the information space equals the total number of words and word collocations taken into account in the analysis. The number of times each word or word collocation appears in earlier collected materials is specified as a distance from the origin of coordinate system measured along the corresponding coordinate axis. It is obvious that, at any moment of time, one, and only one, point of the coordinate space corresponds to each subscriber of personalized information. This correspondence, in one sense, characterizes the topical interests of subscribers. A natural limitation of this approach to information space organization is that it is not applicable to analyze non-textual, e.g., video, information materials.

Appropriate topical classification allows establishment of one-to-one correspondence between points of both types of information space. Therefore, they can be considered as identical.

Independently, with construction of an information space, an evolution of a subscriber's topical interests during any period of time may be represented by a trajectory in this space. If a subscriber's topical interests were fixed only at some discrete moments, an analytical equation of trajectory may be found by interpolation of discrete values in given information space. Then an information vector may be defined as a vector tangent to this trajectory in each its point. This vector characterizes a direction in which a subscriber's topical interests are changing. The length of information vector may be defined as derivative of the trajectory function at a given point. It characterizes how fast a subscriber's topical interests are changing at a specific moment of time.

In order to predict new topical interests of a subscriber, it is sufficient to extrapolate the trajectory of his topical interests outside that period of time where investigation has been carried out. The precision of a prediction depends on the quality of the fixing of topical interests at an arbitrary moment of time (error of method) and on the selected method of approximation of the discrete set of points by a continuous function (error of approximation).

The evolution of group interests of any number of subscribers of personalized information may be reflected by one of the two methods. First of all, it is possible to carry out a cumulative analysis of interests of all members of the group (for example, on the basis of total number of information materials in various topical fields applied by all members of the group, or by evaluating of frequency with which some words or word collocations appeared in all information materials collected by all members of the group) and representing the result by a single point in the information space. Then the problem of prediction of topical fields for any group of users or all the subscribers of personalized information becomes identical to that for individual subscribers. Result achieved in such a way will be essentially of an integral character.

More precise estimation of the evolution of group interests may be found by analyzing the total number of individual trajectories for all subscribers of personalized information or members of any group. In this case of the prediction of topical interests, a cumulative investigation of all information vectors is required for each moment of time. The most prospective direction of evolution of the group interests will be in the neighborhood where the dominant number of information vectors is grouped. The lack of such direction points out incompatibility of individual members of the group in a sense of their topical interests.

Basic System Architecture

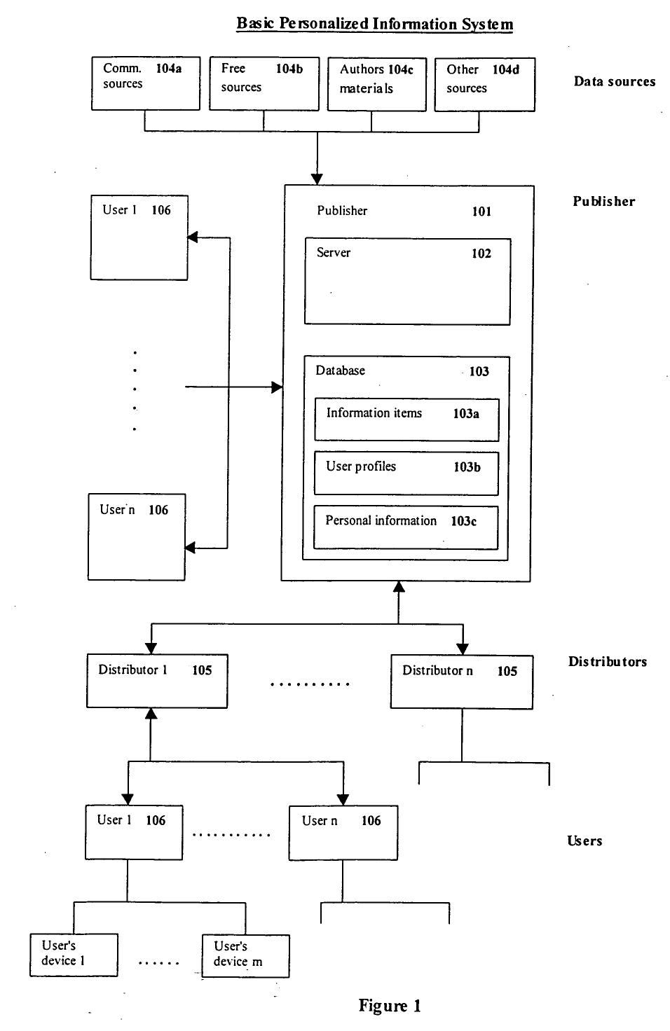

A basic embodiment of the present invention is illustrated in FIG. 1. A publisher 101 collects information items 103a from licensed commercial sources 102a, free sources 102b, independent authors 102c and other 102d for storage on a database 103. Users 106 register with the publisher 101 to receive personalized information 103c and submit a user profile 103b. The user 106 receives personalized information 103c comprising a collection of the information items 103a based, at least in part, on the user's user profile 103b. The user 106 can register directly with the publisher 101 or indirectly with distributor 105 who is allowed to choose a certain percentage of the information items 103a to be included in the user's personalized information 103c.

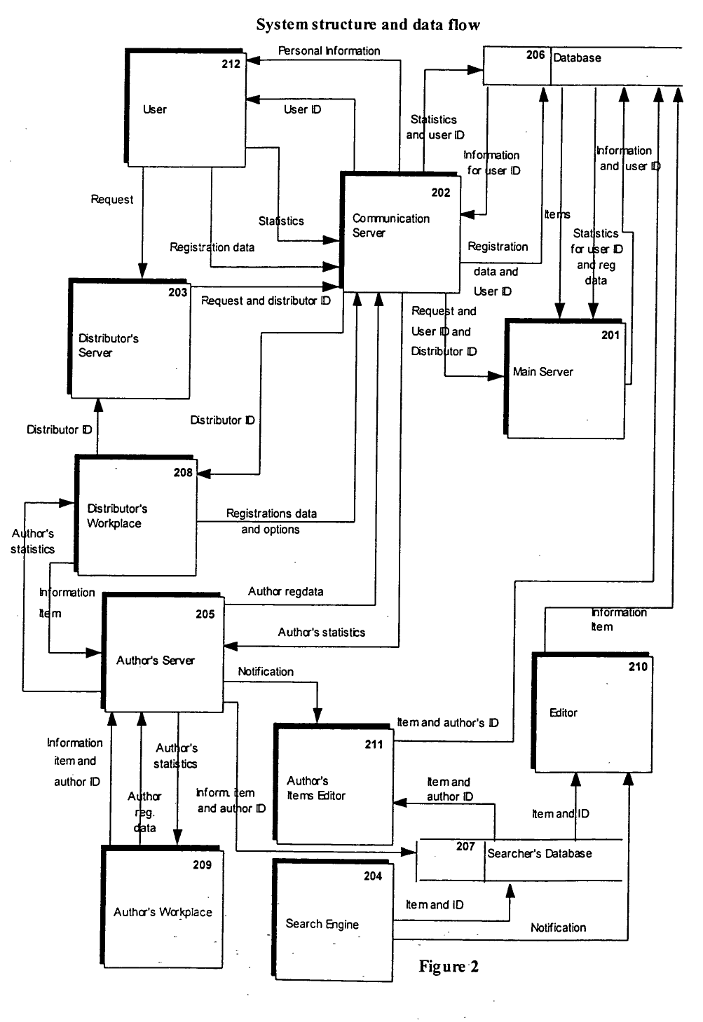

Users 106 send subjective responses to the publisher 101 or the distributor 105. These responses are used to refine the user's profile 103b and can be additionally subject to independent analysis for further use, such as for marketing or public opinion tracking. Publisher 101 can also analyze the responses to identify areas where further information items 103a need to be collected. FIG. 2 represents a block diagram showing the structure of the system, message flows and the functional interface between the system's individual components.

An exemplary system for generating personalized information and delivering issues to users includes the following server components for the preparation and distribution. The publisher's main server 201 is intended to analyze user preferences and perform the main functions associated with the generation of issues based on individual statistics of user-collected materials which reflect the user's field of interest, generally referred to as user profiles. The publisher's communication server 202 is intended to process user requests and deliver current issues of personalized information.

The server 203 of an independent distributing company, hereinafter “distributor”, registers users and provides its subscribers with a specialized issue, preferably incorporating those materials which fall within the independent distributor's field of interest.

A publisher's search engine 204 is used to search for new information items within a predefined set of authorized sources, including news, topical and other Internet sites. An author's server 205 allows independent authors and distributors of specialized publications to supply their materials to the publisher's server 201. A central database 206 is intended to store prepared issues of personalized information and selected new materials. A search database 207 is intended for temporary storage of information items retrieved from various information sources or received via the author's server 205 from independent authors.

The system for generation and delivery of issues contains auxiliary workstations to be used to prepare authors' materials, edit and select documents received from various information sources and from independent authors and to generate specialized issues of personalized information. A distributor's workstation 208, with appropriate software, is intended to identify the topical fields for their specialized issues of personalized information, prepare topical and advertising materials, set up the parameters of the publication and collect statistical data on the work of the users. An author's workstation 209, with appropriate software, allows the independent author to supply his information items to the system and to track statistics of their use. The information editor's workstation 210, with appropriate software, is intended for preliminary processing, evaluation and classification of information items received from various information sources. The authored material editor's workstation 211, with appropriate software, is intended for preliminary processing and evaluation of information items supplied by independent authors. The workstations 212 of the system's users, with appropriate software, allow the user to work with personalized information, and also is used for registration and user profile setup.

The system works as follows. A user of the system can, using appropriate software, receive one or more sets of personalized information and work with them. In order to subscribe to receive personalized information issues, the user should contact the site of the publisher or one of the independent distributors, obtain the identifier of the publication, contact the publisher's communication server 202 or server 203 of one of the independent distributors and register himself as subscriber.

In order to begin the process and to generate a first issue, the user may select, out of the set offered to him, the topical fields most corresponding to the user's field of interest in order to setup of the system's main parameters in the form of a user profile. One of the most important parameters determines the mode of delivery to the user of issues of the personalized information: upon request, according to a schedule, upon accumulation of a user-defined amount of materials or upon the occurrence of a certain other event. The topical fields and setup options selected by the user will be forwarded to the publisher's main server 201 via the communication server 202 or the server 203 of an independent distributor.

In order to retrieve the current issue of the personalized information, the software of the user's workstation 212 should apply to the publisher's communication server 202 directly or via the server 203 of an independent distributor.

The request for the current issue of the personalized information goes from the user's workstation 212 to the communication server 202. Once the user's request is received, the communication server 202 will check whether the central database 206 contains any current issue for this user. If there is no such issue, the communication server 202 will request the main server 201 to generate it. The newly generated issue will come to the central database 206 and then, via the communication server 202, will be dispatched to the user 212 directly or via a distributor's server 203.

The publisher's main server 201 generates a new issue of the personalized information personally for each user or group of users on the basis of the individual or group user profile kept in the central database 206, taking into account the individual user setup and the publication's overall setup. To generate the issue, the information items available in the publisher's central database 206 will be used.

Each new issue of the personalized information will be delivered to the user's workstation 212 directly via the publisher's communication server 202 or via a distributor's server 203.

Subjective responses to the current issue's content made by the user can be automatically dispatched by the software of the user's workstation 212 to the communication server 202 and forwarded to the publisher's main server 201. User responses to any items provided will be sent in a formalized manner to the same address. Based on these responses sent by each user, the publisher's main server 201 adjusts that user's current user profile.

The publisher's search engine 204 tracks the appearance of new materials within a predefined set of authorized information sources and places any materials found in the search database 207. The set of information sources to be used to search for information items (e.g. news and topical Internet sites) will be determined by the search engine's setup. Specific data on the information source for each material will also be stored in the search database 207.

The editor at his workstation 210 performs preliminary processing of information items from the search database 207 (general assessment of usability in issues of the personalized information, elementary editing, such as advertisement removal, indexing and classification into topical fields, etc.). Any items accepted will be forwarded to the publisher's central database 206 for further utilization in generating new issues of the personalized information.

Independent authors from their workstations 209 deliver information items they have prepared to the author's server 205. The author's server 205 places the items so received in the search database 207. The software of each author's workstation 209 also allows him to monitor statistical data on the use of his information items in the issues of the personalized information. The authored material editor, at his workstation 211, performs preliminary processing of authors' items from the search database 207 (general assessment of usability in issues of the personalized information, indexing and classification into topical fields, etc.). Any materials accepted will be forwarded to the publisher's central database 206 for further utilization in generating new issues of the personalized information.

An independent distributor of personalized information registers his specialized information publication using the software installed in his workstation 208 via the publisher's communication server 202 and receives in response a unique identifier of the specialized publication so registered. After registration he will send to the communication server 202 a general set of the specialized publication's parameters (title, topical fields etc.) which will be stored in the publisher's central database 206. In response, the registered independent distributor will receive from the communication server 202 a software code fragment which should be installed in his server 203 in order to serve the users of the personalized information who have subscribed to the specialized publication through the server 203 of the said distributor.

From his workstation 208, an independent distributor of the personalized information can send to the author's server 205 topical and advertising materials which will be included in issues of the specialized publication on a priority basis, generally as a certain percentage of the content.

The specialized software of the user's workstation 212 will perform three main functions: send requests for the registration of system users to the communication server 202 or the server 203 of an independent distributor, support setup of basic working parameters to make user profiles and enable users to work with each current issue of the personalized information furnished to them.

Multilevel System Architecture

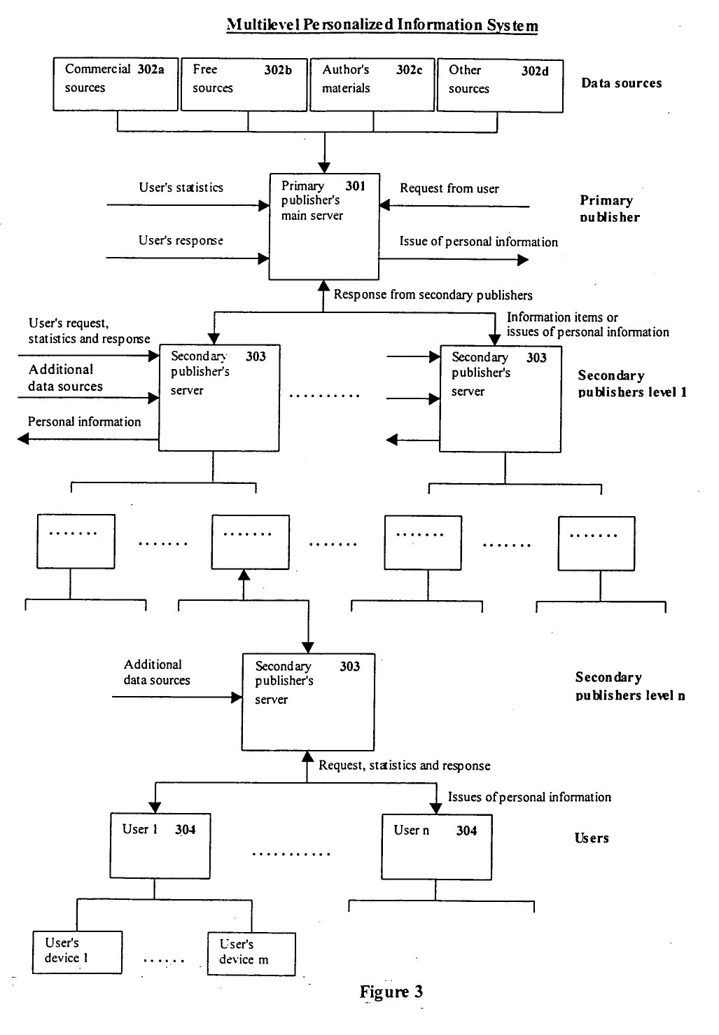

A multilevel embodiment of the present invention is illustrated in FIG. 3. This embodiment is an extended and more powerful version of this invention for regular delivery to users of personalized information. It is intended for generation and delivery to users of general purpose and specialized personalized information in maximum conformity to profiles based on users fields of interests, individual preferences and psychological type. In general, it works in a manner similar to a single publisher embodiment of this invention, but has a number of new features ensuring enhanced selectivity, customization, flexibility, and reliability of delivery.

The principal role in organization of a multilevel information system is played by its primary publisher 301. This entity is responsible for publication in general. But now its main function consists not only in generation of issues of personalized information, but also the creation and support of a wide web of the distributors, named further as secondary publishers 303. In this embodiment, secondary publishers 303 are organized in a multilevel hierarchical structure and play a more active role in preparation and distribution of issues of personalized information. The user 304 is allowed to subscribe for personalized information through publishers at any level, including the primary publisher 301.

The primary publisher 301 is on the top of the hierarchy and receives information items from a predefined set of authorized information sources 302, such as licensed commercial sources like news agencies, free sources such as government publications, and from the independent authors who prepare information items directly for given issues. The access to these sources 302 is carried out through the search and author's servers of the primary publisher 301. All newly retrieved information items are evaluated for usability in future issues of personalized information, preliminarily indexed and classified into topical fields, and transferred to the publisher's central database. After that, the selected items may be used immediately by primary publisher 301 for the generation of issues for his subscribers, and also be transferred to lower level secondary publishers 303 for generation of their own personalized information. The primary publisher 301 is responsible for all publications released by lower level secondary publishers 303 and also for information items submitted to them.

The personalized information generated by the primary publisher 301 is usually of the most general character and is not concerned with specific topical fields. The centralized search for information materials by the primary publisher 301 allows releasing secondary publishers 303 from the lease of expensive dedicated information channels and does not require them to use powerful computers for search, indexing and classification of an information. If necessary, secondary publishers 303 are allowed to order the primary publisher 301 to search for information items on concrete topical fields. As a result, a central information database is created on the primary publisher's server. This database is updated continuously and used to generate issues of personalized information by publishers of various levels. Secondary publishers 303 are also able to transfer their information items into the database of primary publisher 301.

Secondary publishers 303 ether assist primary publisher 301 in generation and distribution of issues of personalized information released by him, or generate their own issues of personalized information. The latter may be general purpose publications like those of the primary publisher 301, but differ from it by using a different approach to information selection and feedback collection with personalized information's users. However, they may offer to their subscribers some specialized issues of personalized information reflecting, in particular, their own topical interests. This is achieved by establishing a number of topical sections reflecting a structure of a specialized publication. So, for instance, a car showroom owner could become a publisher or distributor of a specialized publication devoted to automobile issues, and its subscribers would receive the most complete information on this specific topic. The lower the secondary publisher 303 is in the multilevel hierarchy, the more specialized the issue of personalized information it generates for its subscribers. The issues of specialized personalized information are prepared by the primary publisher 301 by the order from one of the secondary publishers 303 or directly by the secondary publisher 303 using information items available to it.

All the information items needed by secondary publishers 303 are received either from higher level publishers or from their own information sources. These sources may be both various information channels and independent authors who prepare items by the order of the secondary publisher 303. The items produced by the authors may be of a very specialized character, reflecting the field of interest of the publisher. The items received from higher level secondary publishers 303 may, if necessary, be preliminary indexed and classified into topical fields and are transferred together with corresponding classification tables. In order to collect some additional information items and collaborate with the independent authors, the secondary publisher 303 should have his own search and author's servers.

On demand of the primary publisher 301 or one of the higher level secondary publishers 303, all the information items retrieved by secondary publishers 303 can be sent to higher levels for evaluation of their quality and usability for issues of general and specialized publications. Thereby, the primary publisher 301 gains an opportunity to inspect all the issues of personalized information of various levels. Moreover, the information items of secondary publishers 303 may be transferred into central database of primary publisher 301 enlarging common information fund.

Secondary publishers 303 may require the primary publisher 301 or any other higher level secondary publisher to transfer to him only completely generated issues of personalized information and not have any additional sources of information. In this case such secondary publishers 303 would look quite similar to the independent distributors mentioned earlier. The only difference is the hierarchical structure of publishers and distributors, which now will provide users more specialized personalized information.

Independent authors can prepare information items by either proceeding from their own fields of interest, or by the direct order from one of the publishers. All authors' items can be stored in a local data base of the secondary publisher 303 to which they were given. Publishers of any level of hierarchy may transfer their own authors' and other items to a central data base of the primary publisher 301 for consequent use in the issues of personalized information by other publishers. Likewise, the direct exchange by any information items between publishers of the same or different hierarchical levels, without their preservation in a data base of the primary publisher 301, is allowed.

Anyone who has access to the information server of the primary publisher 301 or one of the secondary publishers 303 over the Internet or via any other communication channel or connection may subscribe to an issue of personalized information. To this end, it is enough for the user to register on the server of the primary or one of the secondary publishers 303, indicating an initial field of interest and carrying out some additional setup in order to define the method for delivery of the issue, the volume of each issue, etc., in the form of a user profile. Registration through a secondary publisher's server enables the prospective user to receive a specialized issue preferably including text, audio and video items on a certain topic, which reflects the field of interest of the secondary publisher.

In order to adapt new issues of personalized information as much as possible to the interests and preferences of the users, a user profile will be generated on the primary or secondary publisher's server for each registered user or group of users. Initially, such a profile may be defined by the topical sections selected by the user and by the core topic of the specialized publication. It will further be adjusted, first, on the basis of a review of processed data on the items previously collected by the user and, second, on the basis of a review of any responses received from the user concerning the quality of the items and their conformity with the field of his interest. This establishes a dynamic feedback of the personalized information's users directly to its publisher. For the users forming a group according to their interests, their common profile will be generated as a group profile, subject to adjustment through analyzing the topics of the items collected by all members of the group and any responses received from them.

The user profiles of all the users registered through servers of secondary publishers 303, are automatically forwarded to the information server of the primary publisher 301 and are stored in the central data base. They are used by the primary publisher's server for selection of information items that match the profile of the users. The selected items are transferred to the information server of the secondary publisher together with the corresponding classification tables.

In order to predict the most important topical trends, the primary or secondary publishers generate information vectors via a user's user profile. This is done by having user profiles include a set of N topical fields of interest and assigning a significance magnitude for each topical field to create an N-dimensional information space. Means are then employed to analyze user responses to update the significance magnitude for each topical field. A trajectory in said information space is interpolated based on the updated significance magnitudes and an information vector is defined as a vector tangent to said trajectory with a magnitude defined as the derivative of the trajectory function at a given point to characterize how fast and in what direction a user profile is changing. These information vectors can then be used to assist in directing collection information items.

Any information vector reflects the evolution of topical interests and preferences of the user, group of users or all subscribers of personalized information during any period of time. Its direction in information space determines those topical fields, which will be of a greatest interest in the nearest future. Analyzing a set of information vectors for all subscribers of personalized information, it is possible to forecast some general tendencies of what information items should be collected.

A user's response to each specific item published in any issue of the personalized information will be forwarded to the publisher's server, either as an evaluation of the quality of the information material and its conformity with the user's field of interest, or in the form of comments. Quality may be evaluated using a certain conventional scale in points or in a similar manner, e.g. by appropriate positioning of the marker on the display of the user terminal. Comments are represented by ordinary text expressing the user's detailed attitude towards the material supplied. Either way, the user's response should be transmitted to the publisher's server in a formalized manner suitable for automatic computer processing. The user's response can be entered and transmitted to the publisher's server using a scanning device.

The responses of the users registered through the server of one of the secondary publishers 303, are ether treated immediately by the server of this secondary publisher without forwarding them to the server of the primary publisher 301, or directed to the server of the primary publisher 301. In the former case, the server of the primary publisher 301 indirectly knows about user's responses to published items analyzing user profiles of the users. Each secondary publisher may introduce his own method for users' responses processing. If the responses are carried out on the server of the primary publisher 301, then, together with user's responses, the secondary publisher should direct to the primary publisher's server appropriate procedures for their processing.

Users' responses to published items are useful not only for refining user profiles, but may also be used independently for other specialized reasons. It is likely, for example, that if the information items have some specialized trend, the responses to them could be considered as marketing research or public opinion data. In this case, the responses collected in an appropriate way may be offered to some interested persons or companies on various terms for independent analysis.

The delivery to the user of the next issue of personalized information is carried out through the server of secondary publisher or distributor, which has registered the given user. Through the communication server of the primary publisher 301, the issues of personalized information are delivered only to those users who were registered immediately through the server of the primary publisher 301. The communication server of the primary publisher 301 serves all lower level secondary publishers 303. If desired, the issues of personalized information generated by any level secondary publisher could be transferred into the central data base of the primary publisher 301. Otherwise they can be stored in a local data base of the secondary publisher. In order to receive the next issue of publication, the user should first contact the server of his publisher or distributor indicating his individual password or identifier. One of the available delivery options should be selected by the user as part of the system's setup. The simplest of them is delivery at the user's direct request sent to the publisher's or distributor's server. Another basic option is delivery of current issues according to a used-defined schedule. More complicated options require a user to specify an event upon the occurrence of which a new issue should be delivered to the user. An example of such an event is the accumulation of a user-defined amount of unpublished information items, which should be enough to generate a new issue. The user 304 can also authorize a selected third party to determine delivery parameters.

Logical Organization of Personalized Information

A logical model of the personalized information is established by a primary or secondary publisher and determines internal rules, algorithms, interconnections, list of services, methods of settlements, and etc. Examples of logical models are:
methods for users' responses processing;
interfaces of user workplaces and interactive tools;
algorithms for taking into account individual user profiles during generation of information publication for common use; and
algorithms for prediction of necessities of users of information publication in goods and services through analysis of users' responses.
   Primary publishers may establish some restrictions on the possibility of secondary publishers to introduce their own logical models of personal information. In turn, secondary publishers can establish some restrictions for secondary publishers of lower levels of hierarchy.

Logical models of personalized information are developed by publishers themselves or provided to primary or secondary publishers by some independent suppliers such as independent specialists or companies in replay to specific request. Any logical model of personalized information developed or acquired by primary or secondary publisher may be forwarded to another primary or secondary publisher. Publishers of any level of hierarchy are allowed to operate with logical models in a quite similar manner as done with information items.

Exemplary Uses and Embodiments

An exemplary application of the present invention is as a personalized newspaper that can be delivered in a variety of electronic formats. In one embodiment, a publisher maintains a database of articles collected from licensed commercial information sources (i.e. Associated Press, Reuters, etc.), free information sources (i.e. non-copyrightable U.S. Government information), and articles submitted by independent authors. Articles are indexed (i.e. subject, category, subcategory, etc) automatically and/or by humans.

Users register to receive personalized newspaper and submit a user profile. Although registration can be done directly with publisher, usually for some form of remuneration, a user can also register, usually for free, via a secondary publisher or distributor who has a relationship with the publisher. Directly registered users receive newspapers with any chosen percentage of the articles based on their user profile. Users registered through a secondary publisher or distributor receive newspaper from that publisher or distributor with a percentage of the articles and content (advertisements, coupons, etc.) chosen by the secondary publisher or distributor, and the remaining percentage of the articles based on the user's user profile. Users can register subjective responses about the articles with the publisher.

The newspaper can be delivered by the World Wide Web, E-mail, fax or hard copy in the mail, and can be delivered in textual, audio (CD-R, MP3, etc.), and/or video (DVD, QuickTime, etc.) formats. User responses to the articles can be returned in any of the delivery methods (WWW, E-mail, fax, or mail).

In one aspect of the invention, hard copy response forms can be marked up by a user and faxed to the publisher for graphical recognition by software. Such forms can also include a section for composing E-mail messages that can be sent as text files based on handwriting recognition or sent as graphical files.

Responses to the articles submitted to the publisher can be used for a variety of reasons such as e-mail forwarding and giving the authors ratings. In certain situations, such as where the secondary publisher or distributor is a corporation distributing personalized newspapers to their employees, responses to a secondary publisher or distributor's newspaper can be collected by the secondary publisher or distributor and the secondary publisher or distributor may choose which responses, if any, get shared with the publisher.

Authors can receive royalty payments for each time their articles are used and can respond to user requests or to general interests based on user responses.

In one aspect of this embodiment of the invention, users can download their newspaper into personal organizers for future use.

In another aspect of this embodiment, a weekly digest can be sent to a user, preferably as a DVD containing a half-hour to an hour of video highlights.

1-320. (canceled)

321. A method of delivering personalized information to users, comprising:
collecting information items;
storing said information items on at least one database;
associating a plurality of users as a group based on a common attribute;
establishing a group profile for said group and storing said group profiles on at least one database;
periodically delivering a collection of information items to each user as personalized information, wherein at least a portion of information items from said collection is chosen based on said group profile;
collecting group information responses other than information item usage from said group related to group information items; and
refining said group profile based, at least in part, on said group information responses.

322. (canceled)

323. The method of delivering personalized information to users of claim 321, wherein group topical interests, preferences and psychological-types of a plurality of users are fixed in said group profile.

324. The method of delivering personalized information to users of claim 321, wherein said personalized information is delivered by a channel selected from the group consisting of Internet web pages, FTP downloads, e-mail, facsimile transmission, delivered paper hardcopy, magnetic media, optical media, broadcast TV, and radio.

325. The method of delivering personalized information to users of claim 321, wherein said group information responses are collected by a channel selected from the group consisting of Internet web pages, e-mail, facsimile transmission, delivered paper hardcopy, and voice mail.

326-327. (canceled)

328. The method of delivering personalized information to users of claim 321, wherein a filtering algorithm reduces a size of an information item by a method selected from the group consisting of: reducing size of said information item to a specific value while preserving general content of said information item as close as possible, generating a synopsis for an information item on the basis of semantic analysis of said information item, and reducing a size of an information item by preserving only a part of said information item related to a topical field designated in group profile.

330-344. (canceled)

345. The method of delivering personalized information to users of claim 321, wherein a group of users registers to receive said group information with a publisher or secondary publisher by a method selected from the group consisting of: users in said group registering to receive said group information by filling in a standard form, said group of users choosing at least one information collection from a plurality of information collections released by said publisher or secondary publisher, and each user in said group supplying an initial field of topical interest.

346-348. (canceled)

349. The method of delivering personalized information to users of claim 345, wherein each user in said group supplies an initial field of topical interest by selecting some topical sections from a given predefined set.

350. The method of delivering personalized information to users of claim 348, wherein each user in said group supplies an initial field of topical interest by a method chosen from the group consisting of choosing a group profile of one of the earlier registered groups, combining group profiles of any number of groups, specifying a group profile generated by a publisher of said group information, and combinations of any one of these methods with additional selection of some topical sections from a given predefined set.

351. The method of delivering personalized information to users of claim 348, wherein each user in said group supplies an initial field of topical interest referencing to well-known information sources or information publications.

352. The method of delivering personalized information to users of claim 345, wherein psychological-type of each user in said group is evaluated by applying psychological tests for input into the group profile.

353. The method of delivering personalized information to users of claim 345, wherein each user in said group chooses a condition determinative of a periodic delivery of said group information selected from the group consisting of: a user's request for specific information, a user-defined schedule, a specific event chosen by a user, and an accumulation of a user-defined amount of undelivered information items.

354-357. (canceled)

358. The method of delivering personalized information to users of claim 345, wherein a group profile is created during registration.

359. The method of delivering personalized information to users of claim 358, wherein at least a portion of information submitted during registration, including user's field of interest, is stored in said group profile.

360-364. (canceled)

365. The method of delivering personalized information to users of claim 321, wherein said group information responses are selected from the group consisting of subjective views on said information items, user requests, inquiry responses, and formalized user statements.

366. The method of delivering personalized information to users of claim 365, wherein said subjective views on said information items are expressed in a form selected from the group consisting of evaluation of quality using a scale, expression of user's opinion about information items, and comments to submitted information items.

367-377. (canceled)

378. The method of delivering personalized information to users of claim 321, wherein each said collection of information items, in addition to information items fitting the group profile, includes some publisher's information items which are deemed by the publisher to be most important at the time of generation of said collection.

379. The method of delivering personalized information to users of claim 321, wherein a group of users may export their group profile for use by another group.

380-382. (canceled)

383. The method of delivering personalized information to users of claim 382, wherein said certain response is selected from the group consisting of authorizing payment, authorizing release of user information, viewing advertisements, viewing and registering responses to advertisements, viewing information, viewing and registering responses to information, responding to a questionnaire, and responding to a poll.

384-387. (canceled)

388. The method of delivering personalized information to users of claim 321,
wherein a logical model of group information is established by a publisher, comprising:
methods for group information responses analysis;
interfaces of users' workplaces;
algorithms for taking into account group profiles during generation of collections of information items for common use; and
algorithms for prediction of necessities of users of group information in goods and services through analysis of group information responses.

389-422. (canceled)

423. The method of delivering personalized information to users of claim 321, wherein:
group profiles are initially formed by selecting a set of N topical fields of interest and defining a significance magnitude for each topical field to create an N-dimensional information space;
group profiles are refined by analyzing group information responses to update the significance magnitude for each topical field;
a trajectory is interpolated in said information space based on the updated significance magnitudes; and
an information vector is defined as a vector tangent to said trajectory with a magnitude defined as the derivative of the trajectory function at a given point to characterize how fast and in
what directions a group profile is changing.

424-505. (canceled)
